(19) United States
(12) Patent Application Publication
(10) Pub. No.: US 2018/0265331 A1
(43) Pub. Date: Sep. 20, 2018

(54) ELEVATOR COMMUTER BOARDING SYSTEM AND A METHOD THEREOF

(71) Applicant: Otis Elevator Company, Farmington, CT (US)

(72) Inventors: BV Rao, Hyderabad (IN); Sarath Kampati, Cote Saint Luc (CA)

(21) Appl. No.: 15/923,657

(22) Filed: Mar. 16, 2018

(30) Foreign Application Priority Data
Mar. 18, 2017 (IN) 201711009509

(51) Int. Cl. B66B 11/02; B66B 13/30; B66B 3/00; B66B 5/02; B66B 1/46; B66B 9/00

(52) U.S. Cl. CPC B66B 11/0226; B66B 13/30; B66B 3/002; B66B 9/00; B66B 5/02; B66B 1/468; B66B 11/0266

(57) ABSTRACT

The present invention relates generally to the field of elevator systems. More particularly, the invention relates to an elevator commuter boarding system. It teaches an elevator car for moving in a hoistway. The elevator car comprises a floor, a pair of opposing side walls and a fixed back door. In one of the exemplary embodiments it discloses a detachable front door. An indicator unit is installed on each landing signaling availability of the elevator car to the commuters. The floor comprises a retractable platform. The retractable platform is movable between a retracted position within said elevator car and an extended position with said retractable platform disposed beyond the elevator car in a lobby.

### FOREIGN PRIORITY

This application claims priority to Indian Patent Application No. 201711009509, filed Mar. 18, 2017, and all the benefits accruing therefrom under 35 U.S.C. § 119, the contents of which in its entirety are herein incorporated by reference.

### TECHNICAL FIELD OF THE INVENTION

The present invention relates generally to the field of elevator systems. More particularly, the invention relates to an elevator commuter boarding system.

### BACKGROUND AND THE PRIOR ART

An elevator system typically includes a car that moves within a hoistway to carry passengers or cargo between different floors in a building. Elevator safety is always a primary objective for the designers and among other aspects safety of commuters in accessing the elevator car is very important. However, news of numerous incidents witnessed, experienced and reported is not uncommon where the passengers get hit by the automatic sliding doors of the elevators while entering or exiting the car. This may result in serious injuries to the passengers in addition to leaving the passengers in a panic or embarrassing mood.

Present day elevators are fitted with several safety features and are also needed to secure regulatory approvals. One of the provisions conventionally used is providing an adequate time delay during opening and closing of the door of the elevator car.

Another provision is providing a prefixed safely regulated sliding door speed during closing. Yet another provision is to provide a door-blocker that gets actuated through infrared detectors or any other similar detectors.

U.S. Pat. No. 8,813,290 B1 teaches an operable ramp moveable between a step configuration in a stowed position and a ramp configuration in a deployed position designed for ease of use for persons with disabilities.

U.S. Pat. No. 6,558,106 B2 teaches a lifting device for disabled people designed to be permanently installed at a location for overcoming a difference in level between a lower surface and an upper surface.

The prior arts are utility specific and fail to provide a fully secured and safe assembly for an elevator access. The instant invention provides a moving platform for the passenger access in an elevator car. The instant invention therefore provides a platform that rolls over into the lobby and rolls back into the elevator car facilitating a passageway for passenger access to the car. The product has been developed for a building that requires the use of an elevator, for instance, without limitations, use in high storied buildings and hospitals for ensuring convenience to the users.

### OBJECTS OF THE INVENTION

A basic object of the present invention is to overcome the disadvantages/drawbacks of the known art.

Another object of the present invention is to provide an elevator commuter boarding system.

Another object of the present invention is to provide an indicator unit installed on each floor for signaling availability of the elevator car to commuters.

Another object of the present invention is to provide a moving platform for passenger access in an elevator car.

Another object of the present invention is to provide a retractable platform movable between a retracted position within the elevator car and an extended position in which the retractable platform is disposed beyond the elevator car in a lobby.

Another object of the present invention is to facilitate safe passageway for passenger movement in and out of the elevator car.

Another object of the present invention is to assist in multiple commuters' entry and exit in an elevator car.

Another object of the present invention is to provide ease of access for old passengers, kids and pets.

Another object of the present invention is to provide ease of access for carrying heavy and large goods.

Another object of the present invention is to provide a visibility of elevator availability from distance in the lobby.

Yet another object of the present invention is to provide a reduced risk in the high speed elevators.

These and other advantages of the present invention will become readily apparent from the following detailed description read in conjunction with the accompanying drawings.

### SUMMARY OF THE INVENTION

There is provided a movable elevator car platform defining a passageway for passenger access to the car.

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

According to one aspect of the present invention, there is provided an elevator commuter boarding system comprising: an elevator car for moving in a hoistway, the elevator car comprising a floor, a pair of opposing side walls and a back door; a detachable front door; a control mechanism; wherein the floor comprises a retractable platform, the retractable platform movable between a retracted position within said elevator car and an extended position with said retractable platform disposed beyond the elevator car in a lobby, and the detachable front door coupled to the retractable platform and moveable along with the retractable platform.

In another aspect of the instant invention there is provided an elevator system comprising: an elevator car for moving in a hoistway, the elevator car comprising a floor, a pair of opposing side walls and a back door; a detachable front door; a control mechanism; wherein the floor comprises a retractable platform, the retractable platform movable between a retracted position within said elevator car and an extended position with said retractable platform disposed beyond the elevator car in a lobby, and the detachable front door coupled to the retractable platform and moveable along with the retractable platform.

In another aspect of the invention a method of boarding an elevator through an elevator commuter boarding system comprising the steps of: initiating an elevator hall call through a control mechanism; routing an elevator car for moving in a hoistway based on the elevator hall call, selectively advancing a retractable platform disposed on a floor of the elevator car between a retracted position within said elevator car and an extended position with said retractable platform disposed beyond the elevator car along with a detachable front door.

In another aspect of the instant invention there is provided an elevator car for moving in a hoistway, the elevator car comprising a floor, a pair of opposing side walls and a back door; a front door; a control mechanism; wherein the floor comprises a stationary track and a retractable platform, the retractable platform movable between a retracted position within said elevator car and an extended position with said retractable platform disposed beyond the elevator car in a lobby on opening of the front door.

Yet another aspect of the invention provides an elevator comprising: an elevator car for moving in a hoistway, the elevator car comprising a floor, a pair of opposing side walls and a back door; a front door; a control mechanism; wherein the floor comprises a retractable platform, the retractable platform movable between a retracted position within said elevator car and an extended position with said retractable platform is disposed beyond the elevator car in a lobby on opening of the front door.

Yet another aspect of the invention provides a method of boarding an elevator through an elevator commuter boarding system comprising the steps of: initiating an elevator hall call through a control mechanism; routing an elevator car for moving in a hoistway based on the elevator hall call, selectively advancing a retractable platform disposed on a floor of the elevator car between a retracted position within said elevator car and an extended position with said retractable platform disposed beyond the elevator car in a lobby on opening of the front door.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The following drawings are illustrative of particular examples for enabling methods of the present invention, are descriptive of some of the methods, and are not intended to limit the scope of the invention. The drawings are not to scale (unless so stated) and are intended for use in conjunction with the explanations in the following detailed description.

FIG. 1 shows an elevator commuter boarding system with detachable front door as per the first embodiment.

FIG. 2 shows an elevator commuter boarding system with advancing platform as per the first embodiment.

FIG. 3 shows an elevator commuter boarding system with retracting platform as per the first embodiment.

FIG. 4 shows control mechanism for elevator commuter boarding system.

FIG. 5 shows an elevator commuter boarding system with a front door as per the second embodiment.

FIG. 6 shows an elevator commuter boarding system with advancing platform as per the second embodiment.

FIG. 7 shows an elevator commuter boarding system with retracting platform as per the second embodiment.

FIG. 8 shows an exemplary support means.

FIG. 9 shows an exemplary indicator mechanism.

FIG. 10 shows another exemplary indicator mechanism.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF THE ACCOMPANYING DRAWINGS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

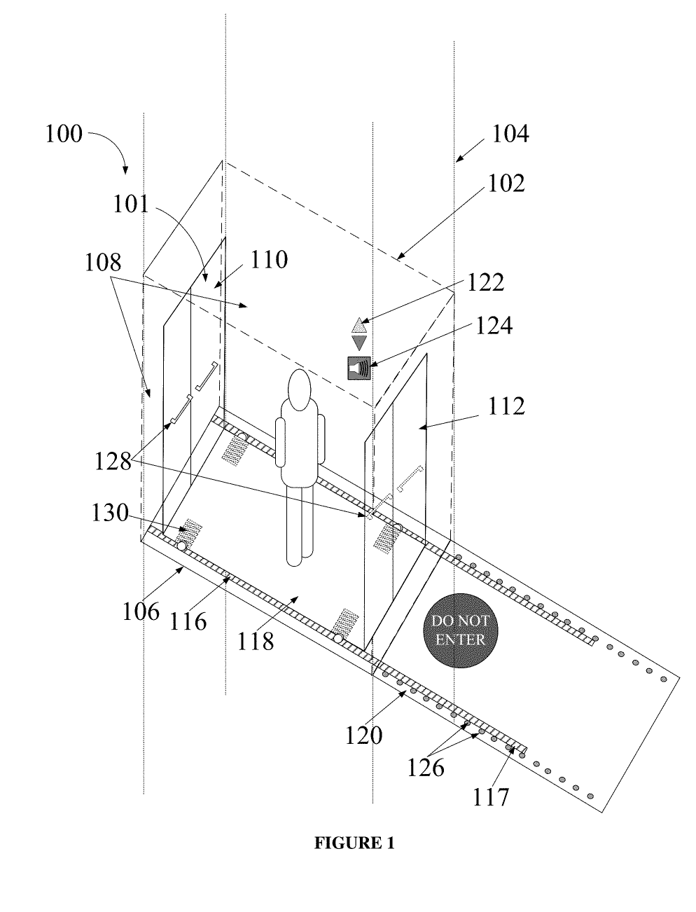

FIG. 1 illustrates an elevator system 100. There is disclosed an elevator commuter boarding system 101 with a detachable front door 112 as per the first embodiment.

An example elevator car 102 moves in a hoistway 104 between different landings in the lobby 120. The elevator car comprises a floor 106, a pair of opposing side walls 108 and a back door 110. The back door 110 is optionally fixed and coupled to advance along with the retractable platform 118. The detachable front door 112 is coupled to the retractable platform 118 to advance beyond the elevator car 102 along with the retractable platform 118. A pair of support means 128 has been provided in the elevator car 102 appropriately for assisting the commuters.

The elevator car 102 is fitted with a plurality of shock absorbers 130 to absorb and damp shock impulses. The disclosed example illustrates a detachable front door 112.

For initiating the elevator hall call, there are many conventional solutions in the form of elevator hall call panel installed at the entrance of the building or in the elevator lobby. Illustratively, an elevator hall call panel having plurality of buttons coupled to the control mechanism 122 can be used for initiating an elevator hall call. The other solutions can be in the form of making a hall call using a device coupled to the control mechanism 122 to facilitate an elevator hall call or any other solution or system known in the art.

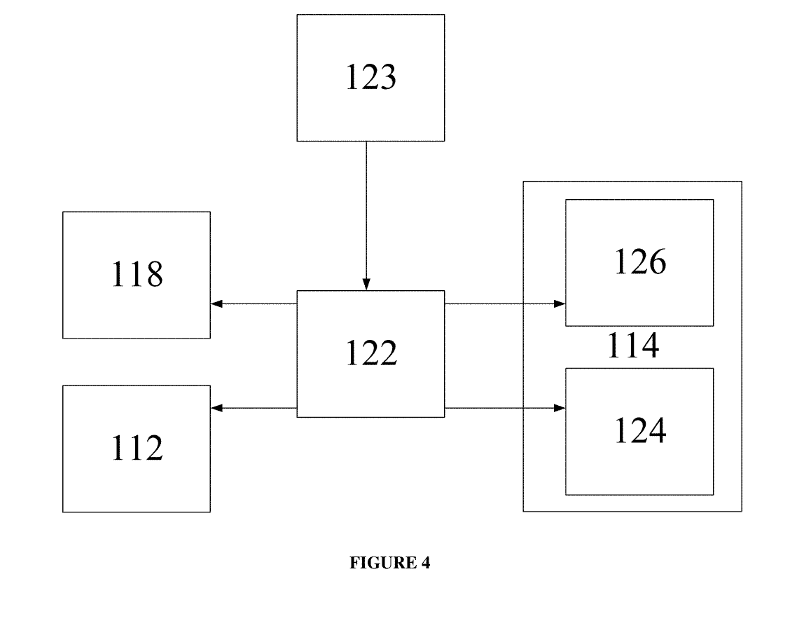

FIG. 1 further illustrates an exemplary audio indicator 124 and a visual indicator 126 installed on each landings in the lobby for signaling availability of the elevator car 102 to commuters. The audio indicator 124 and the visual indicator 126 together forms an indicator unit 114 as shown in FIG. 4 is configured for providing optionally an audio indication 124, a visual indication 126 or both. The indicator unit 114 is coupled to a control mechanism 122 as shown in FIG. 4 for signaling availability of the elevator car 102 to commuters and indicating direction of movement of the elevator car 102. Additionally, the indicator unit 114 is coupled to the control mechanism 122 for signaling advancing and retraction of the retractable platform 118.

In this exemplary embodiment the floor 106 of the elevator car comprises a stationary track 116 and a retractable platform 118. The retractable platform 118 is movable between a retracted position within the elevator car 102 and an extended position in which the retractable platform 118 is disposed beyond the elevator car 102 in a lobby on another stationary track 117. The movement of the retractable platform from the elevator car to the lobby is not limited to this exemplary embodiment wherein it is facilitated through the arrangement of rails and the same can be through a roller arrangement, a magnetic arrangement or the like.

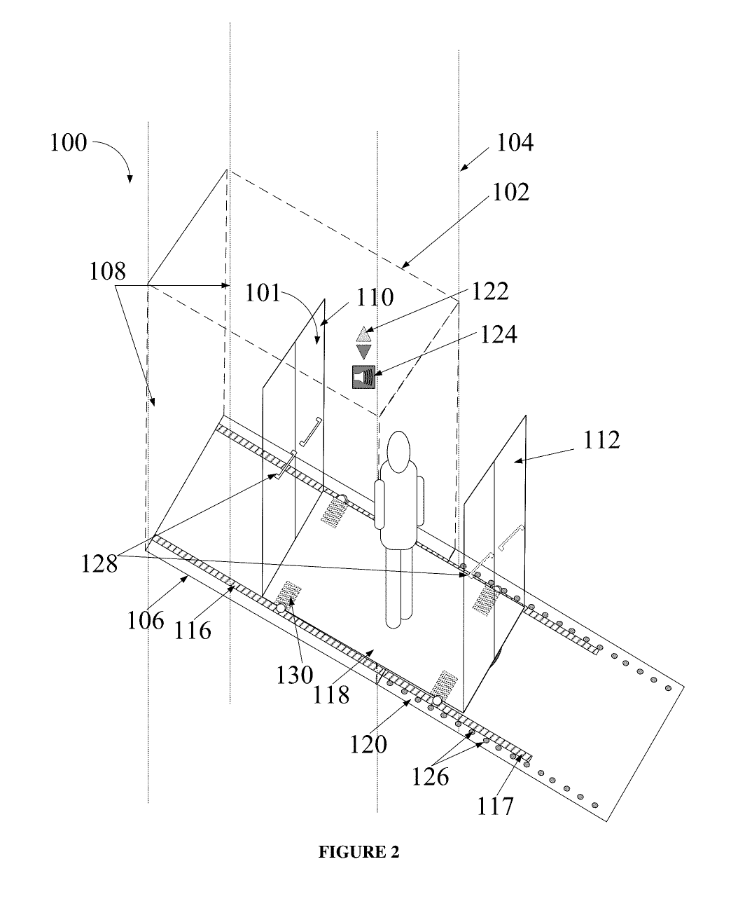

A control mechanism 122 as shown in FIG. 4 including a plurality of sensors selectively advances the retractable platform 118 between a retracted position within the elevator car 102 and an extended position in which the retractable platform is disposed beyond the elevator car 102. The fixed back door 110 is coupled to the retractable platform 118 to advance along with the retractable platform 118. The detachable front door 112 is coupled to the retractable platform 118 to advance beyond the elevator car 102 along with the retractable platform 118 as shown in FIG. 2.

It is understood that the length of the retractable platform 118 has to be commensurate with that of the floor 106 of the elevator car and in no circumstances the length of the retractable platform 118 shall extend more than the floor 106 of the elevator car.

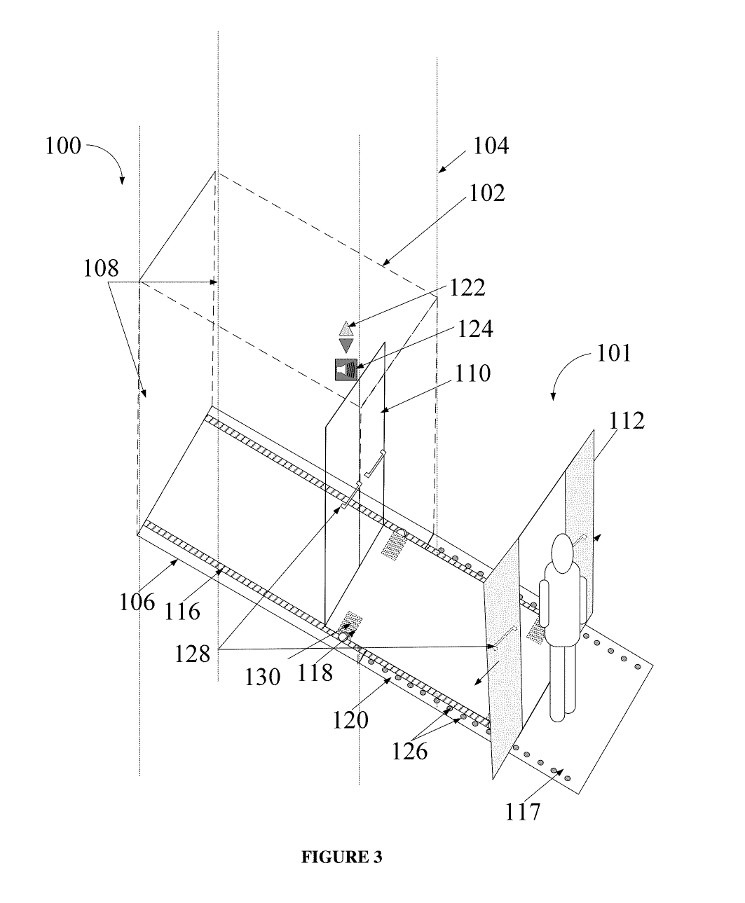

Further, the plurality of sensors 123 as shown in FIG. 4 is configured for ensuring safe advancing of the retractable platform 118 in the lobby 120 as shown in FIG. 3. The instant arrangement provides the retractable platform 118 coupled to the control mechanism 122 for advancing in the lobby in case of an accident.

There is shown in FIG. 4 a control mechanism 122 that takes feeds from the plurality of sensors 123. The control mechanism 122 provides an exemplary indicator unit 114 installed on each landings in the lobby 120 for signaling availability of the elevator car 102 to commuters.

The indicator unit 114 is configured for providing optionally an audio indication 124, a visual indication 126 or both. The indicator unit 114 is coupled to a control mechanism 122 for signaling availability of the elevator car 102 to commuters and indicating direction of movement of the elevator car 102. Additionally, the indicator unit 114 is coupled to the control mechanism 122 for signaling advancing and retraction of the retractable platform 118. The control mechanism 122 processes the information received via different communication channels (not shown) and provides a plurality of indications to the commuters.

Illustratively, the retractable platform 118 can be installed with red and green LEDs. When the retractable platform 118 is in motion or inside the elevator car 102 then the solid red LED will glow. Further, when the retractable platform 118 moves from the elevator car 102 to the lobby 120 and rested, then the solid green LEDs will glow for a predefined time interval. Before the retractable platform 118 starts to move inside the elevator car 102 the blinking green LEDs will indicate the passengers that the retractable platform 118 is ready to move. As soon the retractable platform 118 starts moving, the red LEDs would glow again.

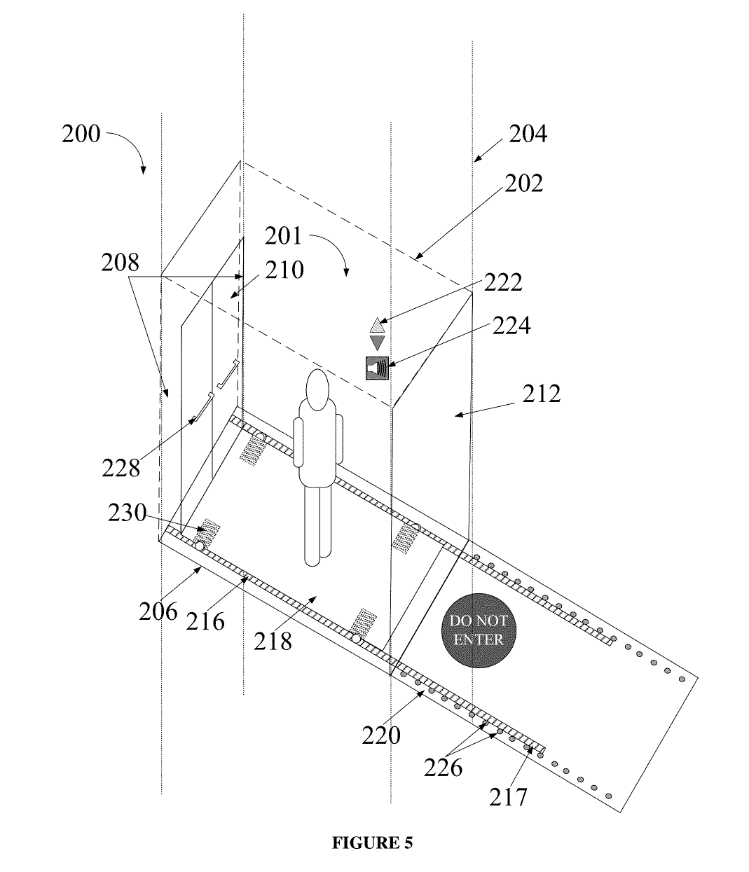

FIG. 5 illustrates an elevator system 200. There is disclosed a commuter boarding system 201 with a front door 212 as per the second embodiment. An example elevator car 202 moves in a hoistway 204 between different landings. The elevator car comprises a floor 206, a pair of opposing side walls 208 and a fixed back door 210. A pair of support means 228 has been provided in the elevator car 102 appropriately for assisting the commuters. The elevator car 202 is fitted with a plurality of shock absorbers 230 to absorb and damp shock impulses. The disclosed example illustrates a front door 212.

It illustrates an exemplary indicator unit 214 installed on each landings in the lobby for signaling availability of the elevator car 202 to commuters. The indicator unit 214 is configured for providing optionally an audio indication 224, a visual indication 226 or both. The indicator unit 214 is coupled to a control mechanism 222 for signaling availability of the elevator car 202 to commuters and indicating direction of movement of the elevator car 202. Additionally, the indicator unit 214 is coupled to the control mechanism 222 for signaling advancing and retraction of the retractable platform 218. There is provided an elevator hall call panel having plurality of buttons coupled to the control mechanism 222 for initiating an elevator hall call.

In this exemplary embodiment the floor 206 of the elevator car comprises a stationary track 216 and a retractable platform 218. The retractable platform 218 is movable between a retracted position within the elevator car 202 and an extended position in which the retractable platform 218 is disposed beyond the elevator car 202 in a lobby on another stationary track 217.

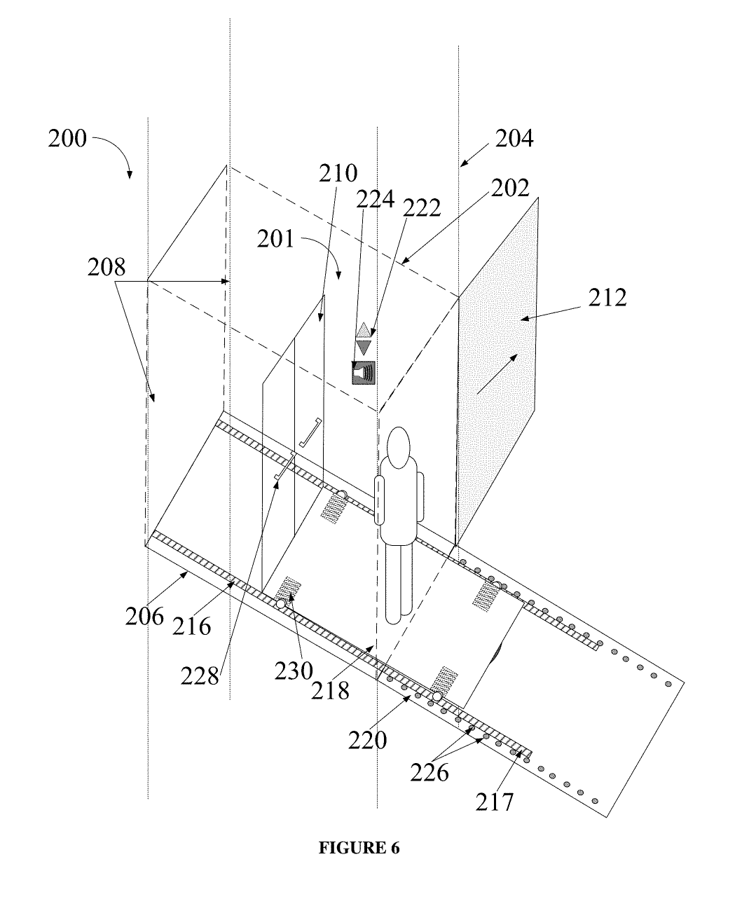

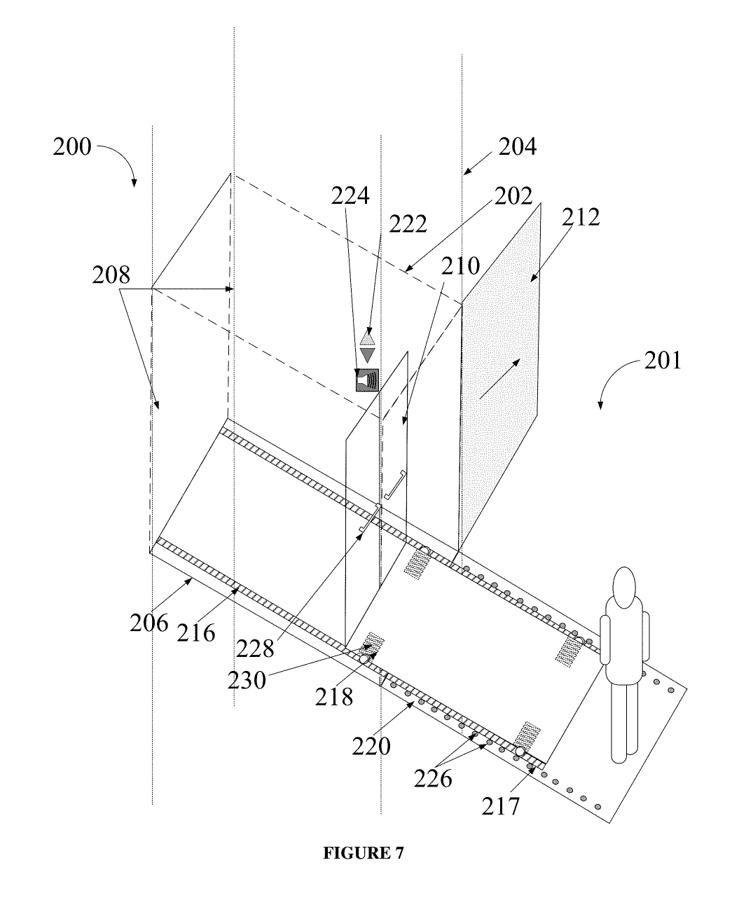

A control mechanism 222 including a plurality of sensors selectively advances the retractable platform 218 between a retracted position within the elevator car 202 and an extended position in which the retractable platform is disposed beyond the elevator car 202. The fixed back door 210 is coupled to the retractable platform 218 to advance along with the retractable platform 218. On opening of the front door 212 at the landing the retractable platform 218 advances beyond the elevator car 202 in the lobby on another stationary track 217 as shown in FIG. 6. Further, the plurality of sensors is configured for ensuring safe advancing of the retractable platform 218 in the lobby as shown in FIG. 7. Further, the arrangement provides the retractable platform 218 coupled to the control mechanism 222 for advancing in the lobby in case of an accident or fire.

Illustratively, as shown in FIG. 7 when the front door 212 opens on the landing in the lobby 220 the retractable platform 218 advances in the lobby 220. The commuters enter the retractable platform 218 and wait for the retractable platform 218 to start moving into the elevator car 202. Retractable platform 218 takes the commuters into the elevator car 202 and applies brakes and the retractable front door 212 closes. The elevator car 202 moves to the desired landing based on the floor selection. Commuter stays on the retractable platform 218 while the elevator car 202 moves to the desired floor. The front door 212 opens and the retractable platform 218 enters the lobby. The retractable platform 218 can be installed with red and green LEDs. When the retractable platform 218 gets in motion or inside the elevator car 202 the solid red LEDs will glow, thus alerting the commuters. As soon the retractable platform 118 moves from the elevator car 202 to the lobby and rested the solid green LEDs will glow for predefined time interval. Before the retractable platform 218 starts to move inside the elevator car 202 the blinking green LEDs will indicate the commuters that the retractable platform 218 is ready to move. Again when the retractable platform 218 starts moving the red LEDs will glow thereby alerts the commuters.

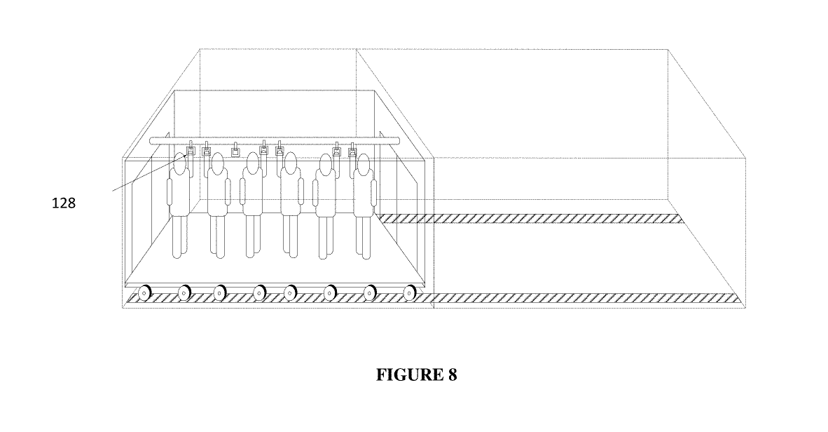

FIG. 8 shows another exemplary illustration of support means 128 providing assistance to commuters in the elevator car 202. The support means can be in the form of fixed attachment on the elevator walls, elevator doors, elevator roof or any other hanging means and the like for providing assistance to the commuters.

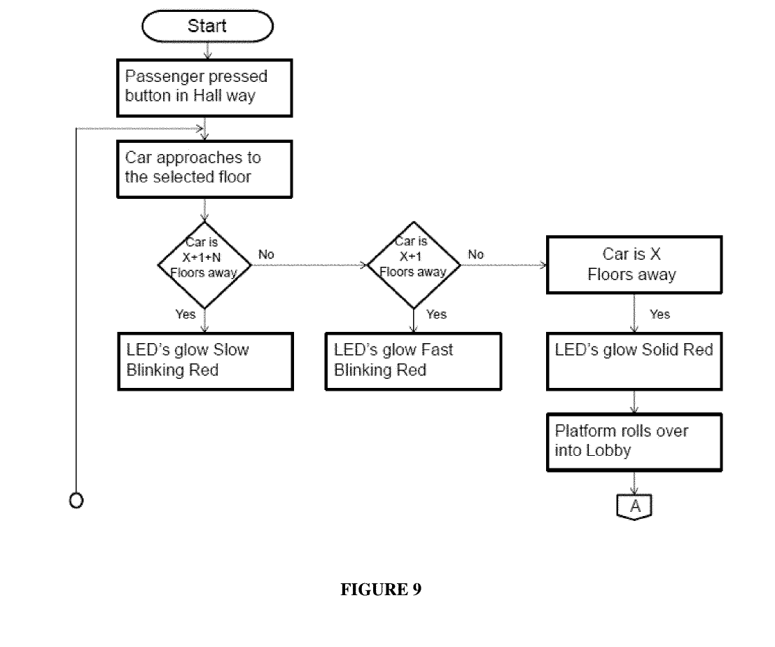

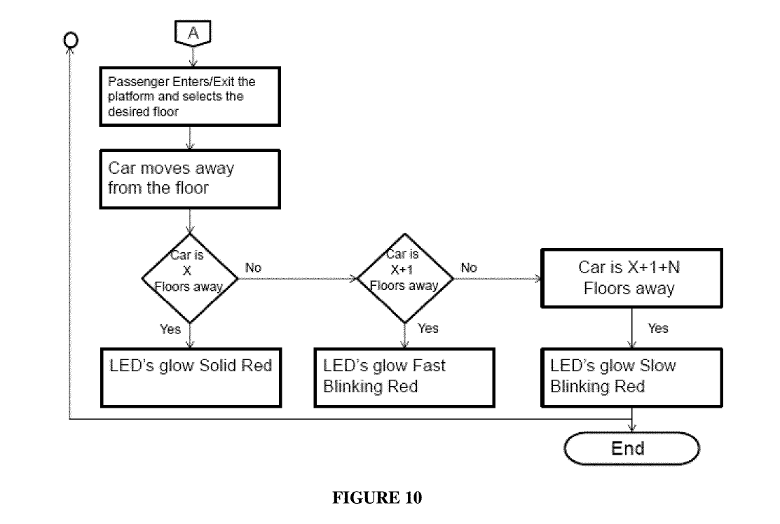

As regards to the visual indication, illustratively as shown in FIGS. 9 and 10, LEDs will be installed in the lobby 220 indicating the movement of the retractable platform 218 to the lobby 220 and into the elevator car 202. In a building having Z number of floors, when the elevator car 202 is on the Zth floor and commuter is waiting on the ground floor, the LEDs on the ground floor will be blinking slowly in red. When the elevator car 202 is approaching the designated floor, the LEDs will start to blink faster in red. When the elevator car 202 is approaching the designated floor with X floors to reach in any direction, the LED's will be solid red. When the elevator car 202 reaches the designated floor, the LEDs will be solid red and the passenger will enter/leave the retractable platform 218. When the elevator car 202 is leaving the designated floor with X floors to reach from any direction, the LEDs will be solid red. When the elevator car 202 is leaving the designated floor with X+1 floor to reach in any direction, the LEDs will start to blink faster in red. When the elevator car 202 leaves the designated floor with X+1+N floor to reach in any direction the LEDs start to blink slower thus alerting the commuters.

Further with regard to audio indication, the same can be installed appropriately to read the pre-defined announcements indicating that the elevator car 202 is approaching the designated floor and warning the commuters to prevent entering in the restricted area wherein the retractable platform advances.

The landing area in the lobby where the retractable platform moves shall preferably be labeled as per the safety standards for instance 5S safety standards to ensure safety of the commuters and conform to various safety standards.

While the exemplary embodiments and illustrations have explained the elevator commuter boarding system in a single entry and exit elevators, it will be appreciated the present invention is applicable to dual/multiple entry and exit elevators.

Advantages:
facilitate safe passageway for passenger movement in and out of the elevator car;
assist in multiple passengers' entry and exit in an elevator car;
Provides ease of access for old passengers, kids and pets;
Provides a visibility of elevator availability from distance in the lobby;
Provides a reduced risk in the high speed elevators;
Provides safety in case of a free fall;
In case of fire in the hoist way or in the building, the passengers can be rolled in to the lobby automatically;
The retractable platform facilitates easier movement of goods and prevents damages caused by sliding doors;
The wait time of the car in the designated floor will be reduced because multiple passengers can access the car at the same time;
Provides a unique design.

Although the embodiments herein are described with various specific embodiments, it will be obvious for a person skilled in the art to practice the embodiments herein with modifications.

However, all such modifications are deemed to be within the scope of the invention. It is also to be understood that the description is intended to cover all of the generic and specific features of the embodiments described herein and all the statements of the scope of the embodiments which as a matter of language might be said to fall there between.

1. An elevator commuter boarding system comprising:
an elevator car for moving in a hoistway, the elevator car comprising a floor, a pair of opposing side walls and a back door;
a detachable front door;
a control mechanism;
wherein the floor comprises a retractable platform, the retractable platform movable between a retracted position within said elevator car and an extended position with said retractable platform disposed beyond the elevator car in a lobby, and the detachable front door coupled to the retractable platform and moveable along with the retractable platform.

2. The elevator commuter boarding system according to claim 1, wherein the control mechanism selectively advances said retractable platform between the retracted position and the extended position.

3. The elevator commuter boarding system according to claim 1, wherein the back door is optionally fixed and coupled to advance along with the retractable platform.

4. The elevator commuter boarding system according to claim 1, wherein the floor further comprises a track.

5. The elevator commuter boarding system according to claim 4, wherein the track at least partially received by the sides of the floor and supporting the retractable platform to move between the retracted position and the extended position.

6. The elevator commuter boarding system according to claim 1, further comprising an indicator unit installed on each landing in the lobby coupled to the control mechanism for signaling availability of the elevator car to commuters, indicating direction of movement of the elevator car and signaling advancing and retraction of the retractable platform.

7. The elevator commuter boarding system according to claim 6, wherein the indicator unit comprises an audio indicator and/or, a visual indicator.

8. The elevator commuter boarding system according to claim 1, wherein the elevator car comprises support means for assisting the commuters.

9. The elevator commuter boarding system according to claim 8, wherein the support means is selectively a fixed attachment on the elevator walls, doors, or roof or any other hanging means and the like support for providing assistance to the commuters.

10. The elevator commuter boarding system according to claim 1 wherein the elevator car is fitted with a plurality of shock absorbers to absorb and damp shock impulses.

11. The elevator commuter boarding system according to claim 1 wherein the retractable platform is coupled to the control mechanism for advancing in the lobby in case of an accident or emergency.

12. An elevator system comprising:
an elevator car for moving in a hoistway, the elevator car comprising a floor, a pair of opposing side walls and a back door;
a detachable front door;
a control mechanism;
wherein the floor comprises a retractable platform, the retractable platform movable between a retracted position within said elevator car and an extended position with said retractable platform disposed beyond the elevator car in a lobby, and the detachable front door coupled to the retractable platform and moveable along with the retractable platform.

13. A method of boarding an elevator through an elevator commuter boarding system comprising the steps of:
initiating an elevator hall call through a control mechanism;
routing an elevator car for moving in a hoistway based on the elevator hall call,
selectively advancing a retractable platform disposed on a floor of the elevator car between a retracted position within said elevator car and an extended position with said retractable platform is disposed beyond the elevator car along with a detachable front door.

14. (canceled)

15. (canceled)

16. (canceled)

17. (canceled)

18. (canceled)

19. (canceled)

20. (canceled)

21. An elevator commuter boarding system comprising:
an elevator car for moving in a hoistway, the elevator car comprising a floor, a pair of opposing side walls and a back door;
a front door;
a control mechanism;
wherein the floor comprises a retractable platform, the retractable platform movable between a retracted position within said elevator car and an extended position with said retractable platform disposed beyond the elevator car in a lobby on opening of the front door.

22. (canceled)

23. (canceled)

24. (canceled)

25. (canceled)

26. (canceled)

27. (canceled)

28. (canceled)

29. (canceled)

30. (canceled)

31. (canceled)

32. An elevator comprising:
an elevator car for moving in a hoistway, the elevator car comprising a floor, a pair of opposing side walls and a back door;
a front door;
a control mechanism;
wherein the floor comprises a retractable platform, the retractable platform movable between a retracted position within said elevator car and an extended position with said retractable platform disposed beyond the elevator car in a lobby on opening of the front door.

33. A method of boarding an elevator through an elevator commuter boarding system comprising the steps of:
initiating an elevator hall call through a control mechanism;
routing an elevator car for moving in a hoistway based on the elevator hall call,
selectively advancing a retractable platform disposed on a floor of the elevator car between a retracted position within said elevator car and an extended position with said retractable platform disposed beyond the elevator car in a lobby on opening of the front door.

34. (canceled)

35. (canceled)

36. (canceled)

37. The method according to claim 33 comprising providing an audio indication and/or, a visual indication through the indicator unit.

38. The method according to claim 33 comprising providing assistance to commuters through a support means in the elevator car.

39. The method according to claim 33 comprising absorbing and damping the shock impulses through a plurality of shock absorbers in the elevator car.

40. The method according to claim 33 wherein the retractable platform is coupled to the control mechanism for advancing in the lobby in case of an accident or emergency.
